(19) United States
(12) Patent Application Publication
(10) Pub. No.: US 2016/0172764 A1
(43) Pub. Date: Jun. 16, 2016

(54) Dipole Antenna

(71) Applicant: COMPAL BROADBAND NETWORKS INC., Taipei City (TW)

(72) Inventors: Shin-Chiang Lin, Hsinchu County (TW); Yao-Wen Chang, Hsinchu County (TW); Xiang-Chen Lin, Hsinchu County (TW)

(21) Appl. No.: 14/716,895

(22) Filed: May 20, 2015

(30) Foreign Application Priority Data
Dec. 12, 2014 (TW) 103222119

(51) Int. Cl. H01Q 9/06; H01Q 5/307

(52) U.S. Cl. CPC H01Q 9/065; H01Q 5/307

(57) ABSTRACT

A dipole antenna includes a substrate, a first radiation element, a second radiation element. The first radiation element disposed on the substrate includes a first bent portion and a second bent portion. The second radiation element disposed on the substrate includes a third bent portion and a fourth bent portion. A first feed-in point is disposed between the first bent portion and the second bent portion and a second feed-in point is disposed between the third bent portion and the fourth bent portion. The first radiation element and the second radiation element are spaced apart by a gap and have reflection symmetry with respect to a symmetrical axis.

### BACKGROUND OF THE INVENTION

1. Field of the Invention

The invention relates to a dipole antenna, and more particularly, to a dipole antenna with bent structures for reducing the antenna dimensions and supporting multiple frequency bands.

2. Description of the Prior Art

With the evolving technology in wireless communications, the modern electronic products such as laptop, Personal Digital Assistant (PDA), wireless LAN, mobile phone, smart meter, and USB dongle are able to communicate wirelessly, for example, through the Wi-Fi technology to replace the physical cable for data transmission or receiving. A wireless communication device or system transmits and receives wireless waves via an antenna to deliver or exchange wireless signals and as further to access wireless networks. The communication system of a wireless local network is in generally divided into a plurality of frequency bands; therefore, an antenna complying with operation of multiple frequency bands becomes more demanded. Besides, the trend of the antenna dimensions are getting smaller to accommodate with the same interests, i.e., smaller dimensions, of electronic products.

FIG. 1 illustrates a schematic diagram of a conventional dipole antenna 10. The conventional dipole antenna 10 comprises radiating elements 100 and 102, and a coaxial transmission line 104. The radiating elements 100 and 102 are connected to the signal source and the ground of the coaxial transmission line 104, respectively. The dipole antenna 10 is not required to connect to a ground plane so that it is insensitive to environmental stimuli. However, the dimensions of the dipole antenna 10 are relatively large. The total length of the dipole antenna 10 is about half of the wave length (λ/2), which means the dipole antenna 10 becomes larger when the operating frequency is lowered. Therefore, the conventional dipole antenna 10 is mostly used as an external antenna. However, electronic products with an external antenna do not seem to be stylish, so it lowers the customers' desire to purchase the products. Moreover, the dipole antenna 10 can only operate in a single frequency band so that it cannot meet the demand for the communication system nowadays with multiple frequency bands.

Therefore, it is a common goal in the industry to provide a relative small sized, multi-band supported, efficient, and cost effective antenna.

### SUMMARY OF THE INVENTION

An objective of the present invention is to provide an antenna supporting multi-band operation and having simple structure and favorable efficiency, so as to lower the manufacturing cost of an antenna for mass production.

An embodiment of the present invention discloses a dipole antenna comprising a substrate; a first radiation element disposed on the substrate and comprising a first bent portion and a second bent portion; a second radiation element disposed on the substrate and comprising a third bent portion and a fourth bent portion; a first feed-in point disposed between the first bent portion and the second bent portion; and a second feed-in point disposed between the third bent portion and the fourth bent portion; wherein the first radiation element and the second radiation element are spaced apart by a gap and have reflection symmetry with respect to a symmetrical axis.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a conventional dipole antenna.

FIG. 2 is a schematic diagram illustrating a dipole antenna according to an embodiment of the present invention.

FIG. 3 and FIG. 4 are schematic diagrams illustrating the resonant paths of the low frequency current and the high frequency current in the dipole antenna shown in FIG. 2, respectively.

FIG. 5 is a schematic diagram illustrating return loss of the dipole antenna shown in FIG. 2 operated at 2.4 GHz.

FIG. 6 is a schematic diagram illustrating return loss of the dipole antenna shown in FIG. 2 operated at 5 GHz.

FIG. 7 to FIG. 10 are schematic diagrams illustrating antenna radiation patterns of the dipole antenna shown in FIG. 2 operated at 2.45 GHz, 5.15 GHz, 5.55 GHz, 5.85 GHz, respectively.

FIG. 11 is a schematic diagram illustrating a dipole antenna according to an embodiment of the present invention.

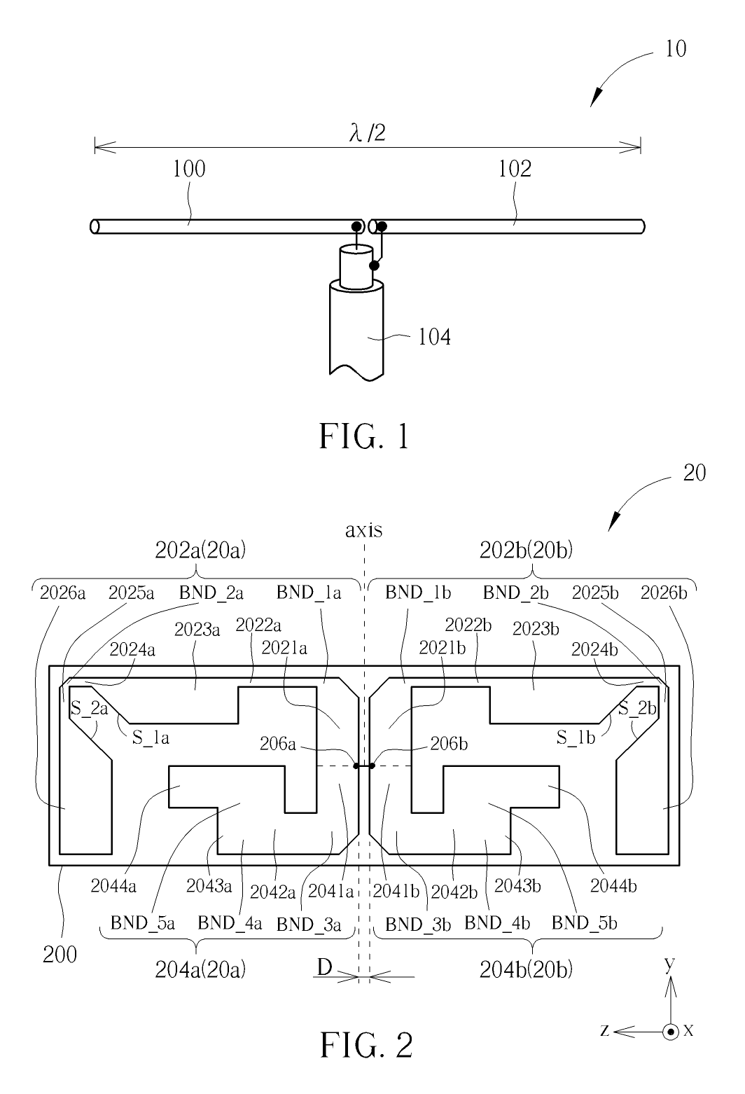

### DETAILED DESCRIPTION

FIG. 2 is a schematic diagram illustrating a dipole antenna 20 according to an embodiment of the present invention. The dipole antenna 20 comprises a substrate 200 which presents as a plane, radiation elements 20a, 20b, and feed-in points 206a and 206b. The radiation elements 20a, 20b formed on the substrate 200 comprise sections 202a, 204a, 202b and 204b respectively. The sections 202a, 204a comprise portions 2021a to 2026a and 2041a to 2044a of different widths and bent portions BND_1a to BND_5a to separate the aforementioned portions. The sections 202b, 204b comprise portion 2021b to 2026b and 2041b to 2044b of different widths and bent portions BND_1b to BND_5b to separate the aforementioned portions. The radiation element 20a and the radiation element 20b have reflection symmetry with respect to a symmetrical axis (axis), and are spaced apart by a gap D. The feed-in points 206a, 206b are formed on the radiation elements 20a, 20b, respectively, to connect to the central conductor and the outer grounded conductor of a coaxial transmission line. The feed-in point 206a is substantially located at the middle point between the bent portion BND_1a and the bent portion BND_3a, while the feed-in point 206b is substantially located at the middle point between the bent portion BND_1b and the bent portion BND_3b. The gap between the feed-in points 206a and 206b is substantially equal to the gap D, and the feed-in points 206a and 206b are symmetric with respect to the symmetrical axis (axis).

In short, the sections 202a, 204a of the radiation element 20a and the sections 202b, 204b of the radiation element 20b form more than one current resonant path of different lengths to support multiple frequency bands. With the portions 2021a to 2026a, 2041a to 2044a, 2021b to 2026b and 2041b to 2044b of different widths, the current resonant path can be further modified to reduce antenna dimensions.

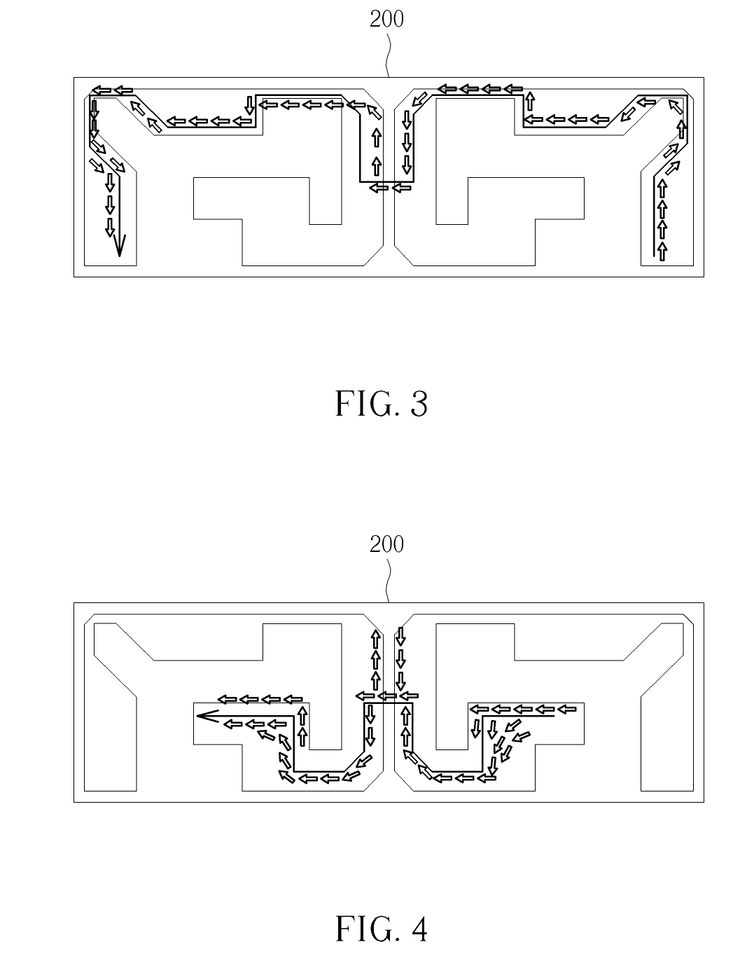

As shown in FIG. 2, the radiation element 20a and the radiation element 20b have reflection symmetry with respect to a symmetrical axis (axis), and lengths of the sections 202a, 202b are longer than those of the sections 204a, 204b. Therefore, there is more than one current resonant path, and each one may have a different length. FIG. 3 and FIG. 4 are schematic diagrams illustrating the resonant paths of the low frequency current and the high frequency current in the dipole antenna 20, respectively. As shown in FIG. 3 and FIG. 4, the dipole antenna 20 has at least two different current resonant paths, in which each current resonant path has a different length. One current resonant path flows from the section 202b of the radiation element 20b to the section 202a of the radiation element 20a via gap D. With proper adjustment of the portion widths of the sections 202a, 202b —for example, the widths of the portions 2023a, 2026a are wider than those of the portions 2022a, 2025a, and the widths of the portions 2023b, 2026b are wider than those of the portions 2022b, 2025b, the current resonant path can be further modified so that the dipole antenna 20 may resonate in a relatively low frequency band. For example, if the length of this current resonant path is 55 mm (i.e., approximately 0.45λ), the dipole antenna 20 may resonate in a 2.4 GHz frequency band. Likewise, the other current resonant path flows from the section 204b of the radiation element 20b to the section 204a of the radiation element 20a via gap D, such that the dipole antenna 20 may resonate in a relatively high frequency band. For example, if the length of this current resonant path is 24.5 mm (i.e., approximately 0.45λ), the dipole antenna 20 may resonate in a 5.2 GHz frequency band. In an example, the dipole antenna 20 may be used as an antenna in a built-in wireless local area network (WLAN) device to transmit and receive 2.4 GHz and 5.2 GHz radio signals, and support multiple wireless communication protocols (e.g. IEEE 802.11 a/b/g/n/ac, Bluetooth, HiperLAN). In such case, the dipole antenna 20 may be fully contained in a narrow space of 30×9.5 mm².

As shown in FIG. 2, the size of the gap D can affect parasitic capacitance between the radiation elements 20a, 20b. Therefore, by proper adjustment of the size of the gap D, electrical characteristics such as impedance matching of the dipole antenna 20 may be achieved and thus radiation efficiency increases.

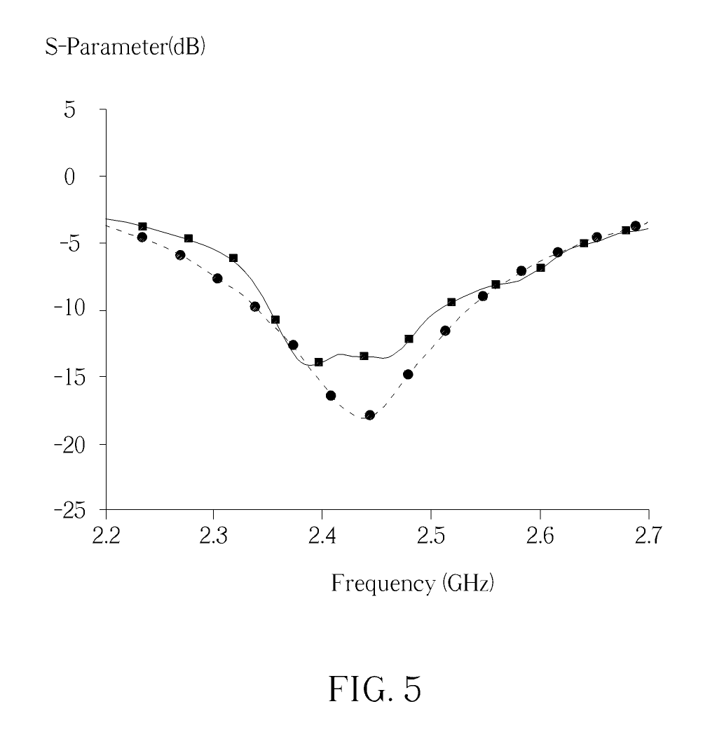

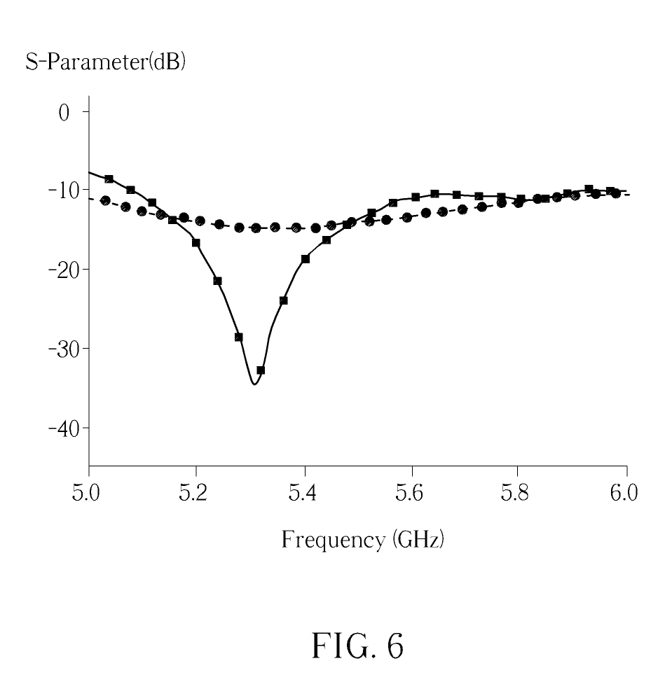

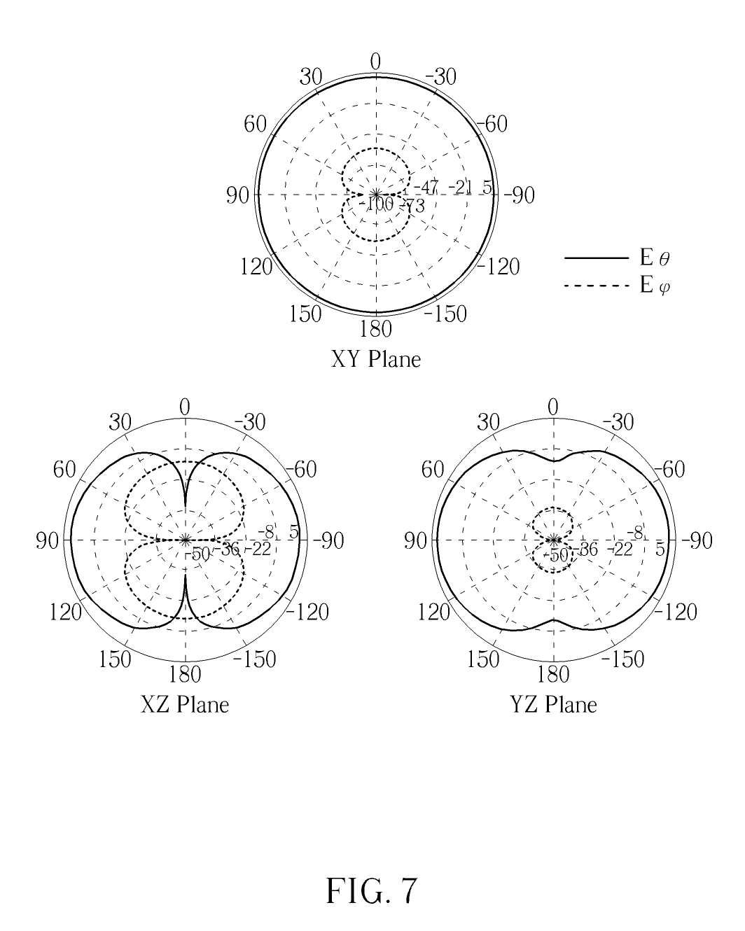

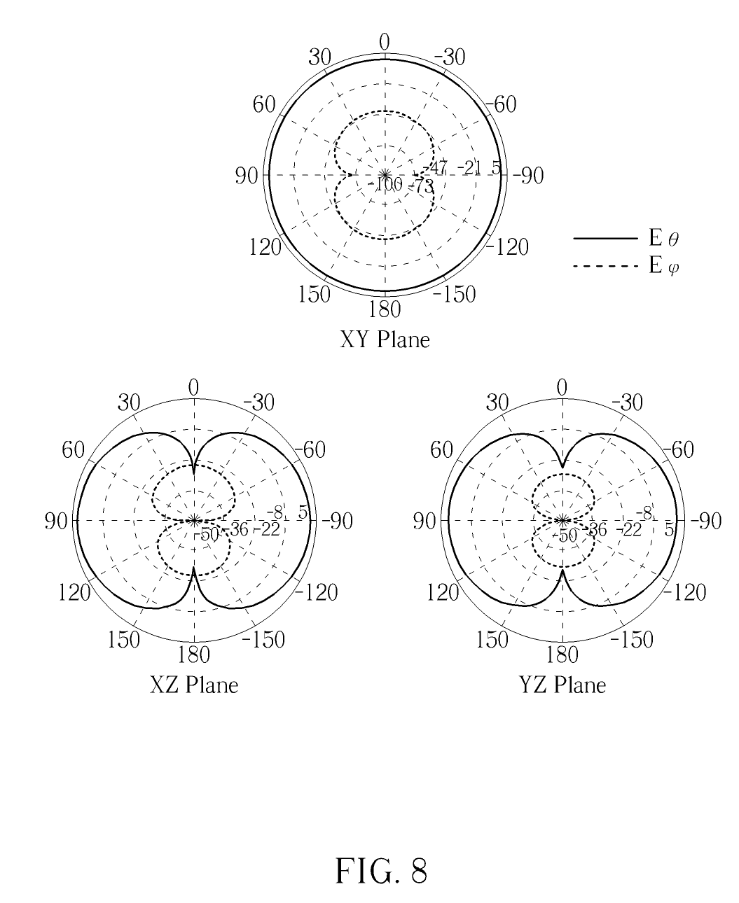

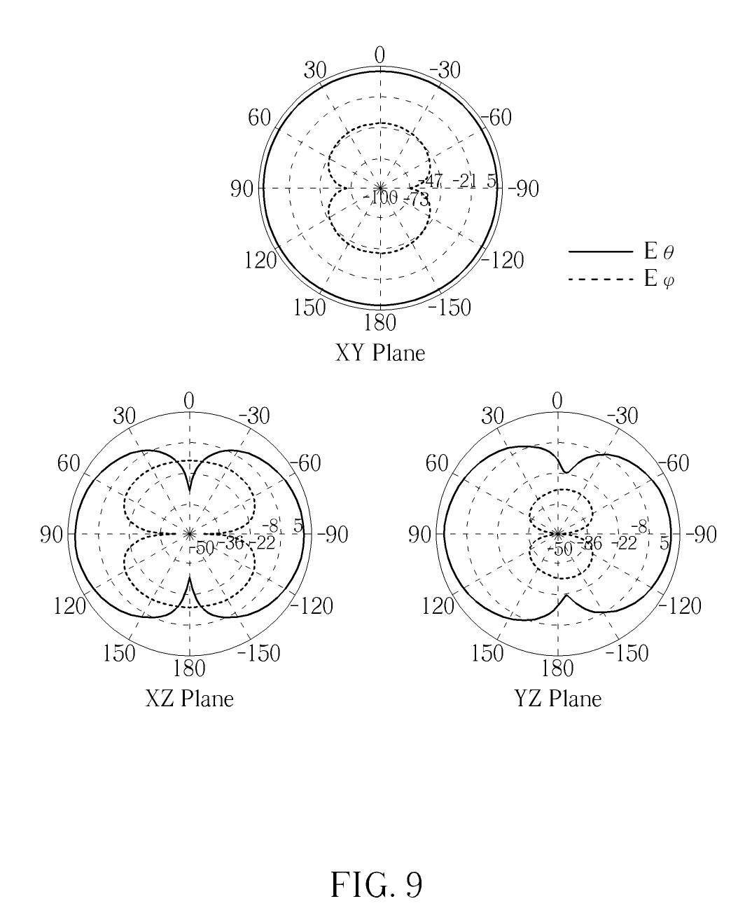

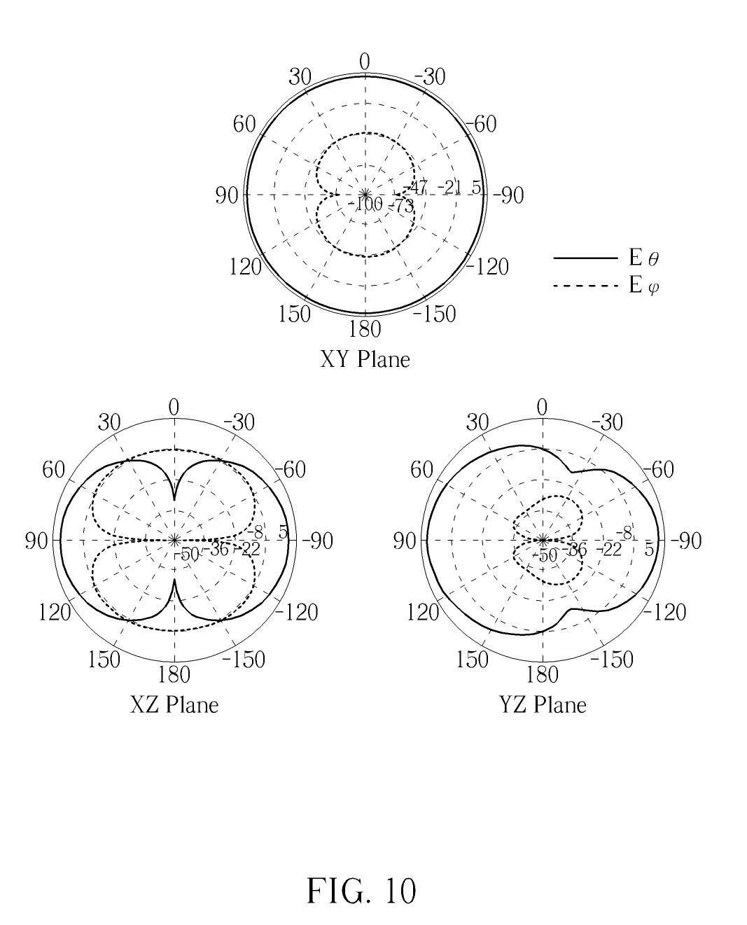

FIG. 5 is a schematic diagram illustrating return loss of the dipole antenna 20 operated at 2.4 GHz. FIG. 6 is a schematic diagram illustrating return loss of the dipole antenna 20 operated at 5 GHz. In FIG. 5 and FIG. 6, the dashed line indicates return loss simulation results of the dipole antenna 20, and the solid line indicates return loss measured results of the dipole antenna 20. As shown in FIG. 5 and FIG. 6, if the gap D is appropriately designed, return loss of the dipole antenna 20 operated at 2.4 GHz and 5 GHz has values substantially below −10 dB, meaning that more than 90% of energy is radiated out into space and that radiation efficiency is enhanced. Namely, there is no need to add a n matching circuit into the dipole antenna 20 of the present invention as in the prior art to improve impedance matching, while impedance matching can be easily achieved by the delicately-designed pattern of the dipole antenna 20 and appropriately-adjusted dimension of the gap D. Table 1 is an antenna characteristic table for the dipole antenna 20 according to measured results. In Table 1, the antenna gain of the dipole antenna 20 is about 1.31 dBi, and the radiation efficiency is about 89.52% when the dipole antenna 20 is operated at 2.4 GHz. The antenna gain of the dipole antenna 20 is about 1.98 dBi, and the radiation efficiency is about 91.58% when the dipole antenna 20 is operated at 5.25 GHz. According to the structure of the dipole antenna 20, an omnidirectional radiation pattern can be formed in the xz plane without nulls. FIG. 7 to FIG. 10 are schematic diagrams illustrating antenna radiation patterns of the dipole antenna 20 at 2.45 GHz, 5.15 GHz, 5.55 GHz, 5.85 GHz, respectively.

TABLE 1

| frequency | antenna gain | antenna efficiency |
|---|---|---|
| (GHz) | (dBi) | (%) |
| 2.40 | 1.31 | 89.52 |
| 2.42 | 1.37 | 90.54 |
| 2.44 | 1.40 | 91.00 |
| 2.46 | 1.40 | 90.90 |
| 2.48 | 1.38 | 90.24 |
| 2.50 | 1.34 | 89.04 |
| 5.15 | 1.91 | 91.36 |
| 5.25 | 1.98 | 91.58 |
| 5.35 | 2.03 | 90.83 |
| 5.45 | 2.10 | 90.33 |
| 5.55 | 2.17 | 90.19 |
| 5.65 | 2.20 | 89.54 |
| 5.75 | 2.15 | 87.72 |
| 5.85 | 1.98 | 84.89 |

The dipole antenna 20 of the present invention uses the sections 202a, 202b, 204a and 204b to create multiple current resonant paths with different lengths. Consequently, the dipole antenna 20 may support multiple operating frequency bands with minimized dimensions compared to the conventional dipole antennas. Those skilled in the art can readily make modifications and/or alterations accordingly. For example, the radiation elements 20a, 20b may be disposed on the substrate 200 by printing and etching processes. The substrate 200 may be a fiber glass composite laminate conforming to the FR4 specifications, and other kinds of dielectric substrate may be used depending on the application. In addition, the dimension of the radiation elements 20a, 20b may be properly adjusted according to the operating frequency requirements.

Furthermore, the number of portions or sections of the radiation elements 20a, 20b can be properly adjusted and thus increased or decreased to any integer for further reducing the dimensions of the dipole antenna 20. Moreover, the outward corner not facing the center of the radiation elements 20a, 20b formed by the bent portions BND_1a to BND_3a and BND_1b to BND_3b may be chamfered to form an oblique angle for reducing the parasitic capacitance due to the effect of bended path. Similarly, the outward corner not facing the center of the radiation elements 20a, 20b formed by the bent portions BND_4a to BND_5a and BND_4b to BND_5b may be chamfered to form an oblique angle, but not limited thereto. Alternatively, the dipole antenna 20 is in the shape of a curve. Alternatively, the inward corner facing the center of the radiation elements 20a, 20b formed by the bent portions BND_1a to BND_5a and BND_1b to BND_5b is a right angle, but is not limited herein. Any angle between 90 to 180 degrees may be used as long as the shape of the antenna complies with the formation of multiple current resonant paths. The radiation element 20a and the radiation element 20b have reflection symmetry; however, the radiation element 20a and the radiation element 20b may be modified to have rotational symmetry with respect to the center of the feed-in points 206a, 206b, which means the radiation elements 20a, 20b appear unchanged even after rotated around the center by 180°, according to the practical consideration of the antenna design. Alternatively, the radiation element 20a and the radiation element 20b may be asymmetric.

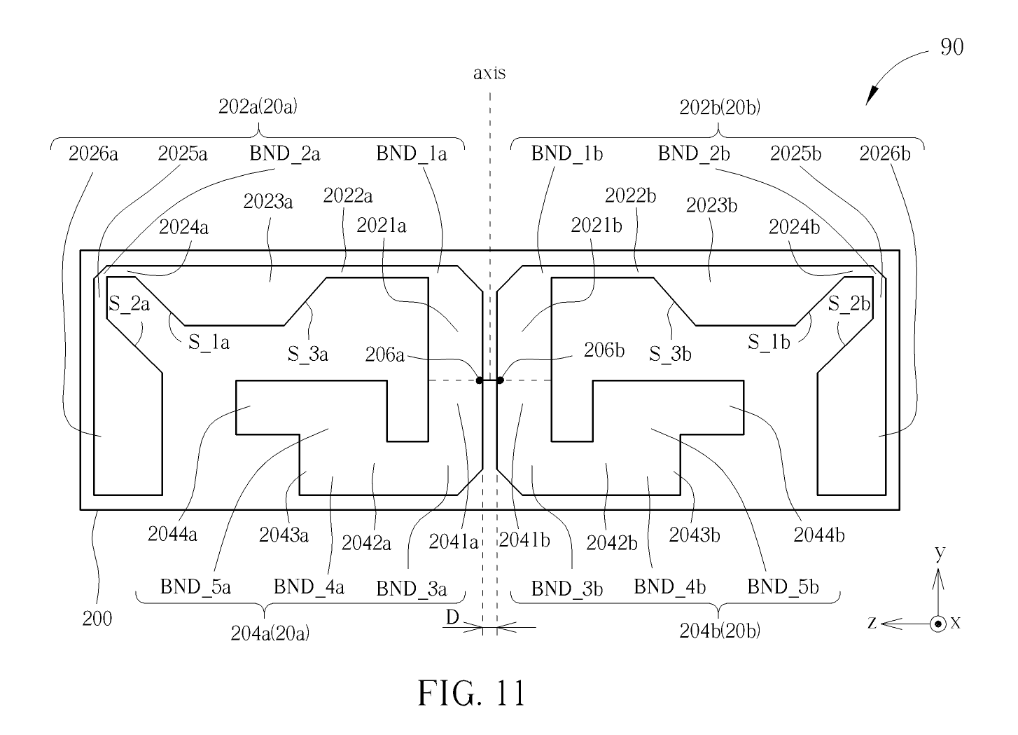

FIG. 11 is a schematic diagram illustrating a dipole antenna 90 according to an embodiment of the present invention. Since the structure of the dipole antenna 90 is similar to that of the dipole antenna 20, the similar parts are not detailed redundantly. Unlike the dipole antenna 20, the dipole antenna 90 comprises hypotenuses S_3a, S_3b apart from the hypotenuses S_1a, S_2a, S_1b and S_2b. In other words, sizes of the widths of the portions 2023a and 2023b gradually increase to improve antenna performance according to system requirements.

In summary, the present invention creates multiple current resonant paths by adjusting the width variation of the radiation elements and inserting a proper feed-in gap such that the dipole antenna can operate in more than one frequency band. In addition, the space required for disposing the dipole antenna is effectively reduced in the present invention, which benefits implementation of an embedded antenna. Moreover, the structure of the dipole antenna in the present invention does not require any via. The dipole antenna of the present invention can be realized on a general printed circuit board (PCB), e.g., an FR4 single layer PCB, for being precisely manufactured and thus achieving good antenna performance. Therefore, the manufacturing cost is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dipole antenna, comprising:
a substrate;
a first radiation element disposed on the substrate, comprising a first bent portion and a second bent portion;
a second radiation element disposed on the substrate, comprising a third bent portion and a fourth bent portion,
a first feed-in point disposed between the first bent portion and the second bent portion; and
a second feed-in point disposed between the third bent portion and the fourth bent portion;
wherein the first radiation element and the second radiation element are spaced apart by a gap and have reflection symmetry with respect to a symmetrical axis.

2. The dipole antenna of claim 1, wherein the first radiation element further comprises:
a fifth bent portion;
a first portion coupled to the first bent portion; and
a second portion coupled between the first portion and the fifth bent portion;
wherein a width of the first portion is not equal to the width of the second portion.

3. The dipole antenna of claim 2, wherein the second portion comprises a hypotenuse.

4. The dipole antenna of claim 1, wherein the first radiation element further comprises:
a third portion coupled to the fifth bent portion; and
a fourth portion coupled to the third portion;
wherein a width of the third portion is not equal to a width of the fourth portion.

5. The dipole antenna of claim 4, wherein the fourth portion comprises a hypotenuse.

6. The dipole antenna of claim 1, wherein the first bent portion, the second bent portion, the third bent portion and the fourth bent portion each has a right angle and is chamfered.

7. The dipole antenna of claim 1, wherein the substrate conforms to FR4 specifications.

8. The dipole antenna of claim 1, wherein the first feed-in point and the second feed-in point are connected to a central conductor and an outer grounded conductor of a coaxial transmission line, respectively.

9. The dipole antenna of claim 1, wherein the first radiation element and the second radiation element are disposed on the substrate by printing and etching processes.
